(19) United States
(12) Patent Application Publication
(10) Pub. No.: US 2016/0247402 A1
(43) Pub. Date: Aug. 25, 2016

(54) VEHICLE LOCATION INDICATOR

(71) Applicant: EMPIRE TECHNOLOGY DEVELOPMENT LLC, WILMINGTON, DE (US)

(72) Inventor: ANPENG HUANG, HAIDIAN DISTRICT (CN)

(21) Appl. No.: 14/425,257

(22) PCT Filed: Feb. 27, 2014
(86) PCT No.: PCT/CN2014/072624

§ 371 Date: Mar. 2, 2015

(51) Int. Cl. G08G 1/137; H04L 29/08

(52) U.S. Cl. CPC G08G 1/137; H04L 67/12

(57) ABSTRACT

Technologies are generally described for methods and systems effective to provide an indication of a location of a first vehicle. In some examples, a processor may receive a request for the location of the first vehicle that includes an identification of the first vehicle. The processor may search for the identification of the first vehicle in a memory associated with a second vehicle. Based on a result of the search, the processor may retrieve location data relating to the location of the first vehicle. The processor may transform the location data into the indication of the location of the first vehicle.

### BACKGROUND

Unless otherwise indicated herein, the materials described in this section are not prior art to the claims in this application and are not admitted to be prior art by inclusion in this section.

In a vehicle-to-vehicle network, vehicles may share data with each other to facilitate execution of various applications. In some examples, vehicles in a vehicle-to-vehicle network may be configured to communicate within a particular communication range. Vehicles in a vehicle-to-vehicle network may be configured to relay data and/or messages to other vehicles in the network.

### SUMMARY

In some examples, methods for providing an indication of a location of a first vehicle are generally described. The methods may include receiving, by a processor, a request for the location of the first vehicle. The request may include an identification of the first vehicle. The methods may also include searching, by the processor, for the identification of the first vehicle in a memory associated with a second vehicle. The methods may also include, based on a result of the search, retrieving, by the processor, location data relating to the location of the first vehicle. The methods may also include transforming, by the processor, the location data into the indication of the location of the first vehicle.

In some examples, methods for generating composite map data are generally described. The methods may include identifying, by a processor, first location data that relates to a first location of a first vehicle. The methods may also include identifying, by the processor, second location data that relates to a second location of a second vehicle configured to be in communication with the first vehicle over a network. The methods may also include transforming, by the processor, the first location data into first map data. The methods may also include transforming, by the processor, the second location data into second map data. The methods may also include generating, by the processor, the composite map data based on the first map data and second map data.

In some examples, systems effective to provide an indication of a location of a first vehicle are generally described. The systems may include a memory in a second vehicle. The systems may also include a component configured to be in communication with the memory. The component may be configured to receive a request from a device for the location of the first vehicle. The request may include an identification of the first vehicle. The component may also be configured to search for the identification of the first vehicle in the memory of the second vehicle. The component may be configured to, based on a result of the search, retrieve location data relating to the location of the first vehicle. The component may also be configured to transform the location data into the indication of the location of the first vehicle. The component may also be configured to send the indication of the location of the first vehicle to the device.

In some examples, methods for determining an indication of a location of a vehicle are generally described. The methods may include generating a request using an identification of the vehicle. The request may be for the location of the vehicle. The methods may also include sending the request to a processor. The methods may also include receiving location data from the processor in response to sending the request. The location data may relate to the location of the vehicle. The methods may also include transforming the location data into the indication of the location of the vehicle.

In some examples, devices configured to determine an indication of a location of a vehicle are generally described. The devices may include a memory configured to store an identification of the vehicle. The devices may further include a component configured to be in communication with the memory. The component may be configured to generate a request with use of the identification of the vehicle. The request may be for the location of the vehicle. The component may also be configured to send the request to a processor. The component may also be configured to receive location data from the processor in response to the request. The location data may relate to the location of the vehicle. The component may also be configured to transform the location data into the indication of the location of the vehicle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement a vehicle location indicator;

FIG. 2 illustrates the example system of FIG. 1 illustrating more detail relating to generation of location data;

FIG. 3 illustrates the example system of FIG. 1 with more detail relating to generation of a composite map;

FIG. 4 illustrates the example system of FIG. 1 relating to an implementation of a vehicle location indicator, where location data of vehicles changes as a location of a requesting device changes;

FIG. 5 illustrates a flow diagram for an example process for implementing a vehicle location indicator;

FIG. 6 illustrates an example computer program product that can be utilized to implement a vehicle location indicator; and

FIG. 7 is a block diagram illustrating an example computing device that is arranged to implement a vehicle location indicator;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to a vehicle location indicator.

Briefly stated, technologies are generally described for methods and systems effective to provide an indication of a location of a first vehicle. In some examples, a processor may receive a request for the location of the first vehicle that includes an identification of the first vehicle. For example, the request may request the location of vehicle ABC. The processor may search for the identification of the first vehicle in a memory associated with a second vehicle. In the example, a processor in a second vehicle may receive the request and search a memory associated with the processor for the identification. Based on a result of the search, the processor may retrieve location data relating to the location of the first vehicle. In the example, the processor may retrieve the information from the memory associated with the processor, or may request and retrieve the information from memories associated with other processors in other vehicles configured to be in communication over a network. The processor may transform the location data into the indication of the location of the first vehicle.

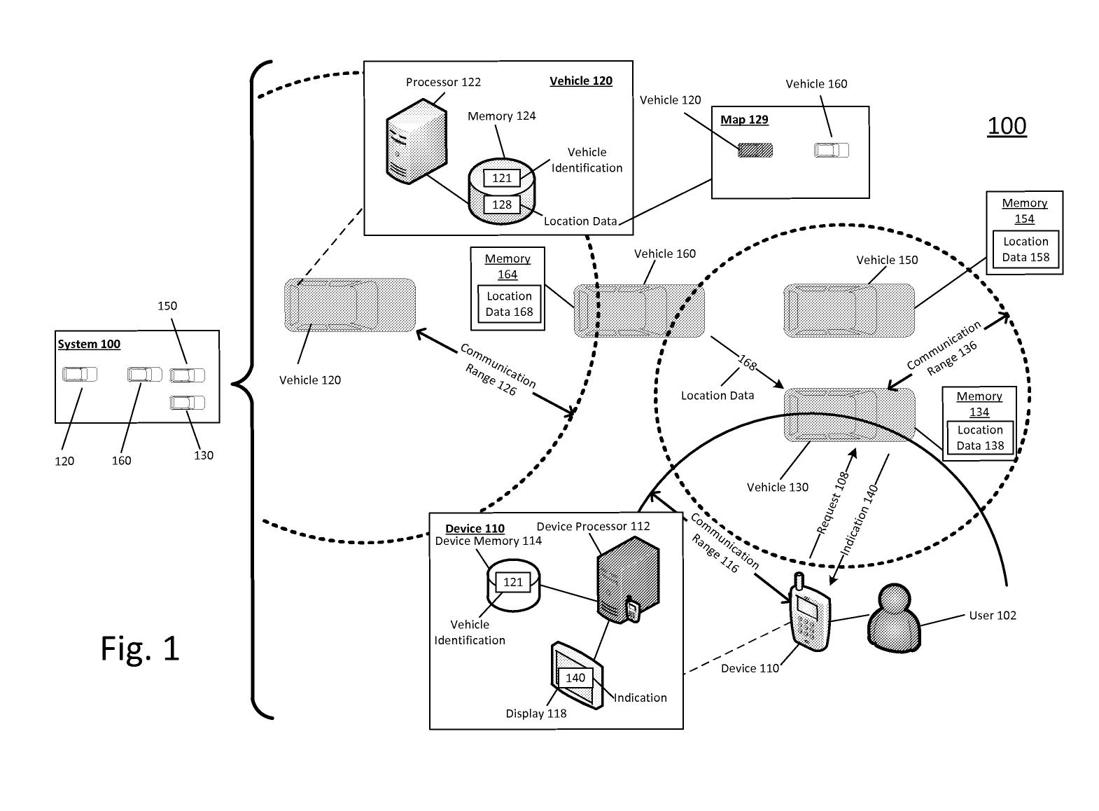

FIG. 1 illustrates an example system 100 that can be utilized to implement a vehicle location indicator, arranged in accordance with at least some embodiments described herein. System 100 may include a device 110 and/or one or more vehicles 120, 130, 150, 160. Device 110 may be a communication device such as a cellular phone and may be used by a user 102 to request an indication of a location of a vehicle. A first vehicle of vehicles 120, 130, 150, 160 may receive the request for an indication of a location of a vehicle and provide a response that includes the indication of the location (that is, a response that indicates the location of the vehicle). Vehicles 120, 130, 150, 160 may each be configured to communicate with one or more other vehicles 120, 130, 150, 160 within a respective communication range. For example, vehicle 130 may be configured to communicate with one or more vehicles, such as vehicle 150 and/or vehicle 160, within a communication range 136. Vehicle 120 may be configured to communicate with one or more vehicles, such as vehicle 160, within a communication range 126. Communication range 126 and communication range 136 may or may not overlap with each other. Device 110 may be configured to communicate with one or more devices or vehicles within a communication range 116. In the example depicted by system 100, device 110 may be located in a particular location such that vehicle 130 is within communication range 116. When vehicle 130 is within communication range 116, device 110 may transmit data to, and receive data from, vehicle 130. Vehicles 120, 130, 150, 160 may be stationary during an implementation of system 100 such as in a parking lot.

Vehicles 120, 130, 150, 160 may each include one or more components such as a processor and/or a memory. In some examples, the component may be installed into one or more vehicles such as by embedding the component onto a processor or device associated with a respective vehicle. Focusing on vehicle 120, vehicle 120 may include a processor 122 configured to be in communication with a memory 124. Processor 122 may be configured to facilitate communication between vehicle 120 and one or more vehicles inside of communication range 126 such as with a transmitter and/or receiver. Memory 124 may be configured to store a vehicle identification 121 that is effective to identify vehicle 120. For example, vehicle identification 121 may be associated with at least a part of a VIN (Vehicle Identification Number) of vehicle 120. In some examples, vehicle identification 121 may be associated with device 110. For example, if device 110 is a cellular phone, vehicle identification 121 may include at least a part of the VIN of vehicle 120 and at least a part of a phone number of device 110.

Memory 124 may further store one or more pieces of location data, such as location data 128, that relates to locations of other vehicles within system 100. Location data 128 may be rendered, such as by processor 122 or device 110, into an indication of a location of one or more vehicles or into a map 129. Map 129 may be effective to show indications of locations of one or more vehicles, such as vehicle 120 and vehicle 160. Processor 122 may be configured to collect vehicle data relating to locations of vehicles within communication range 126. Processor 122 may collect the vehicle data from one or more vehicles within communication range 126 and may compile the collected vehicle data to generate and/or update location data 128 (further described below). Each vehicle in system 100 may include a memory configured to store location data that includes indications of locations of vehicles within a respective communication range. In the example depicted, vehicles 130, 150, 160 may include a memory 134, a memory 154, and a memory 168, respectively. Memories 134, 154, 164 may be configured to store location data 138, 158, 168, respectively. The location data may be rendered, such as by a processor in a respective vehicle, to show indications of locations of vehicles within a respective communication range.

Device 110 may include a device processor 112, a device memory 114, and/or a display 118, and may be, for example, a mobile phone. Device processor 112 may be configured to be in communication with device memory 114 and/or display 118. Device processor 112 may be configured to store vehicle identification 121 of vehicle 120 in device memory 114. Device processor 112 may be further configured to generate a request 108, which may be a request for a location of vehicle 120 and may include vehicle identification 121. Device processor 112 may be further configured to broadcast request 108 to one or more vehicles within communication range 116.

A particular processor associated with a particular vehicle that receives request 108 from device 110 may analyze identification 121 in request 108 such as by determining if identification 121 is a valid vehicle identification. For example, if a valid vehicle identification includes 15 digits and vehicle identification 121 includes 14 digits, the particular processor may determine that vehicle identification 121 is invalid and may interrupt operations of system 100. The processor may search for identification 121 in location data stored in a memory of the particular vehicle. When identification 121 is present in the location data stored in the memory of the particular vehicle, the particular processor may retrieve the location data from the memory of the particular vehicle. When identification 121 is absent from the location data stored in the memory of the particular vehicle, the particular processor may send request 108 to one or more different vehicles to request the indication of the location of vehicle 120. In response to sending request 108 to the one or more different vehicles, the particular vehicle may receive the location data from the one or more different vehicles.

The processor of the particular vehicle may transform the retrieved location data into an indication 140 that may be output from device 110 such as on display 118. Indication 140 may include a geographic direction (e.g., “10 feet north”) effective to navigate a user toward the location of the requested vehicle—in the example, vehicle 120. Indication 140 may include directions, a map, text, etc., effective to direct device 110 and/or user 102 towards the location of vehicle 120. In some examples, indication 140 may include a map generated and compiled from one or more pieces of location data stored in one or more vehicles within system 100.

In an example, when vehicle 130 is inside of communication range 116, a user 102 may use device 110 to send request 108 to vehicle 130. A processor of vehicle 130 may identify vehicle identification 121 in request 108. In response to identification of vehicle identification 121, vehicle 130 may search for vehicle identification 121 in location data 138 stored in memory 134 of vehicle 130. If vehicle 130 detects a presence of vehicle identification 121 in location data 138 stored in memory 134, vehicle 130 may retrieve location data 138 from memory 134 and either send location data 138 to device 110 or may transform location data 138 into indication 140. Vehicle 130 may further send indication 140 to device 110 in order for the indication of the location of vehicle 120 to be shown on display 118 of device 110.

In the example, if vehicle 130 detects an absence of vehicle identification 121 in location data 138 stored in memory 134, vehicle 130 may send request 108 to one or more vehicles, such as vehicles 150, 160, within communication range 136. In the example, vehicle 160 may receive request 108 and, in response, may search for vehicle identification 121 in location data 168 stored in memory 164 of vehicle 160. Vehicle 160 may detect a presence of vehicle identification 121 in location data 168 stored in memory 164 and, in response, may send location data 168 to vehicle 130. Vehicle 160 may also forward request 108 to other vehicles in system 100, starting with vehicles within a communication range of vehicle 160, until vehicle identification 121 is found. Vehicle 130 may receive location data 168 and, in response, may either send location data 138 to device 110 or transform location data 138, 168 into indication 140. Vehicle 130 may further send indication 140 to device 110. Device 110 may receive location data 138 and transform location data 138 into indication 140. Alternatively, device 110 may receive indication 140.

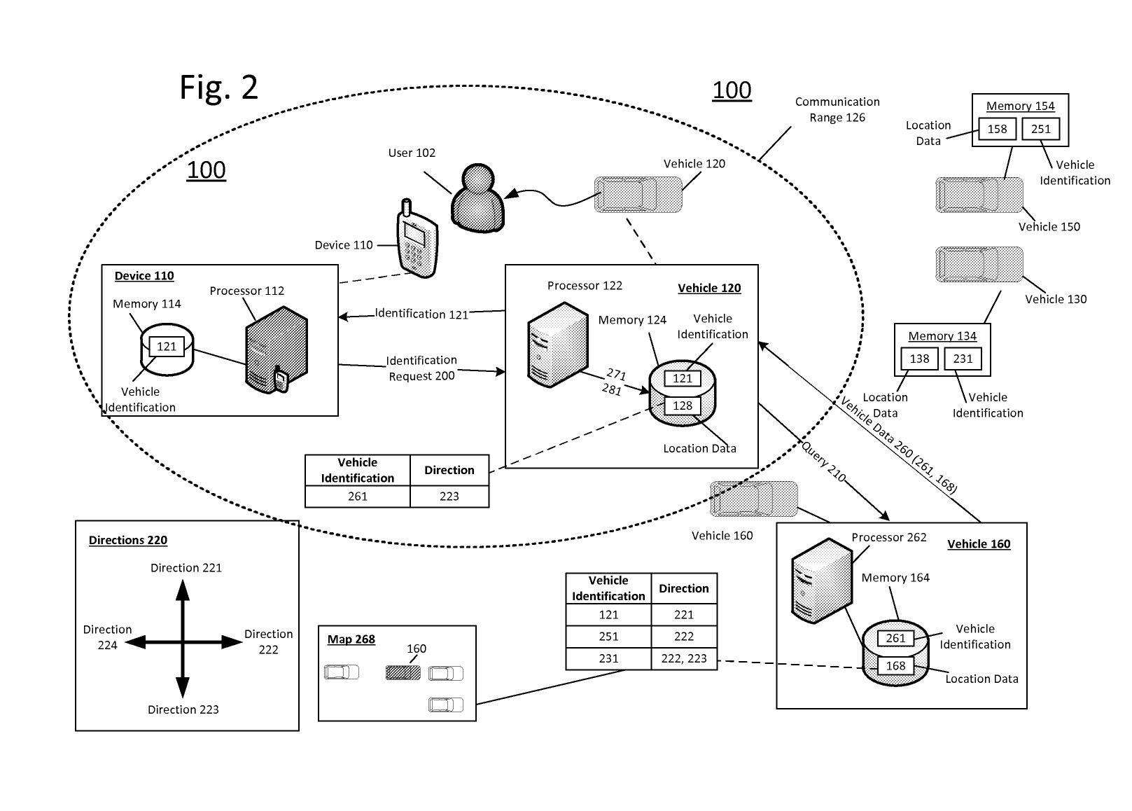

FIG. 2 illustrates system 100 of FIG. 1 illustrating more detail relating to generation of location data, arranged in accordance with at least some embodiments described herein. FIG. 2 is substantially similar to system 100 of FIG. 1, with additional details. Those components in FIG. 2 that are labeled identically to components of FIG. 1 will not be described again for the purposes of clarity.

Vehicles in system 100 may generate location data and/or a map prior to generation of a request for an indication of a location. In an example, user 102 may be an operator of vehicle 120. User 102 and/or device 110 may move away from a location of vehicle 120 such as when user 102 enters a store or leaves a parking lot. While still within communication range 126, user 102 may use device 110 to send an identification request 200 to vehicle 120. Identification request 200 may be a request for vehicle identification 121 of vehicle 120. Processor 122 in vehicle 120 may receive identification request 200 and, in response, may send vehicle identification 121 to device 110. In some examples, identification request 200 may include a key, such as a password, that may be effective for processor 122 to verify device 110. Device processor 112 may receive vehicle identification 121 and, in response, may store vehicle identification 121 in device memory 114.

In the example, vehicle 160 is within communication range 126. Vehicle 160 may further include a processor 262 configured to be in communication with memory 164. Memory 164 may further store a vehicle identification 261 that is effective to identify vehicle 160. Memory 134 of vehicle 130 may further store a vehicle identification 231 that is effective to identify vehicle 130. Memory 154 of vehicle 150 may further store a vehicle identification 251 that is effective to identify vehicle 150.

To generate location data, processor 122 may send a query 210 to one or more vehicles within communication range 126. Query 210 may be a request for vehicle data that corresponds to vehicles within communication range 126. Vehicle data of a respective vehicle may include the respective vehicle identification and/or respective location data. In the example, processor 262 of vehicle 160 may receive query 210 and, in response, may send vehicle data 260, that includes vehicle identification 261 and/or location data 168, to vehicle 120.

In response to sending vehicle data 260 to vehicle 120, processor 262 may update location data 168. Processor 262 may update location 168 based on information in vehicle data 260. For example, if vehicle data 260 includes information identifying a particular location of vehicles 160 and/or 150, such as by latitude and longitude or global positioning system coordinates, processor 262 may update location data 168, to include the location information. Processor 262 may update location data 128 based on a signal strength that corresponds to transmission of query 210. For example, processor 122 of vehicle 120 may send query 210 using ultrasonic signals. Processor 262 may be configured to determine the signal strength and/or frequency sequence of the ultrasonic signal and, in response, determine a distance and/or direction of vehicle 160 relative to the location of vehicle 120. Example directions are shown by the depicted directions 220. Directions 220 may include one or more directions such as directions 221, 222, 223, 224. In the example, processor 262 may determine that vehicle 120 is located in a direction 221 relative to vehicle 160. Processor 262 may update location data 168 such as by logging vehicle identification 121 of vehicle 120 in correspondence with direction 221 in location data 168. Location data 168 may further include pieces of data that indicate locations of other vehicles adjacent to vehicle 160. For example, location data 168 may indicate that vehicle 150 (vehicle identification 251) is located in a direction 222 relative to vehicle 160. Location data 168 may indicate that vehicle 130 (vehicle identification 231) is located in directions 222, 223 relative to vehicle 160. The updated location data 168, when rendered by processor 262, may produce a map 268 that shows the locations of vehicles 120, 130, 150, 160.

In response to receiving vehicle data 260 from vehicle 160, processor 122 of vehicle 120 may generate or update location data 128 based on a signal strength or frequency sequences that correspond to transmission of vehicle data 260. Processor 122 may be configured to determine the signal strength of the signal that corresponds to transmission of vehicle data 260 and, in response, determine a distance and/or direction of vehicle 160 relative to the location of vehicle 120. In the example, processor 122 may determine that vehicle 160 is located in direction 223 relative to vehicle 120. Processor 122 may generate location data 128 such as by logging vehicle identification 261 of vehicle 160 in correspondence with direction 222 in location data 128.

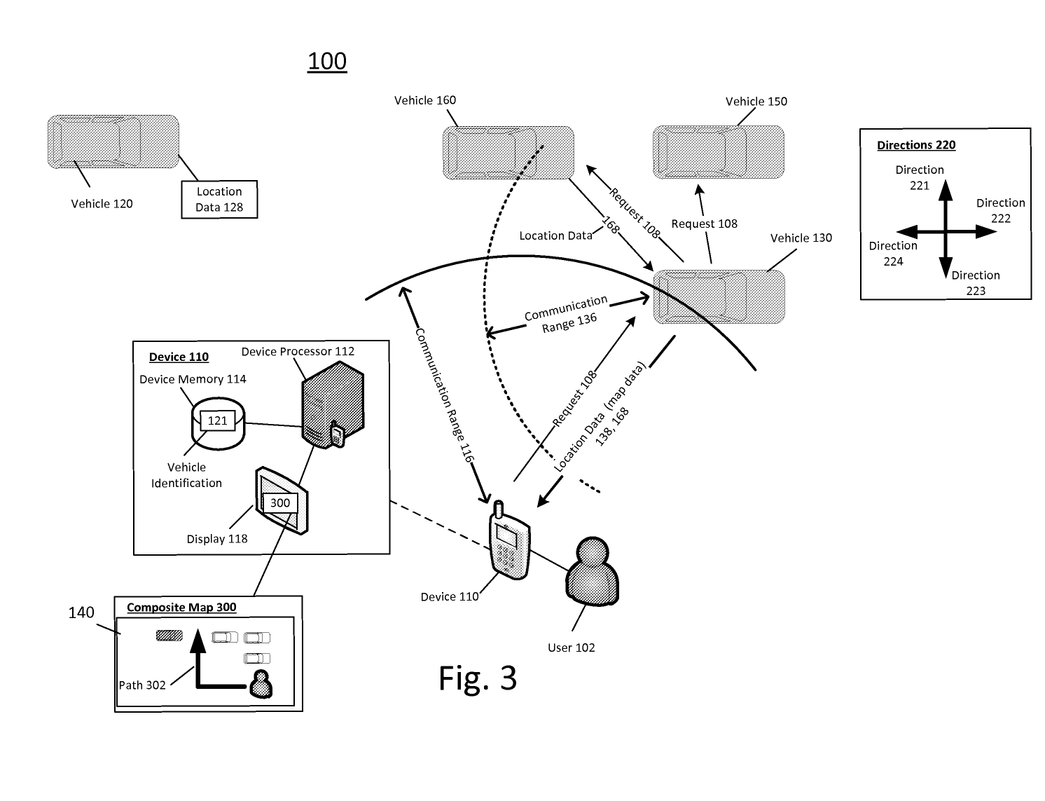

FIG. 3 illustrates system 100 of FIG. 1 with more detail relating to generation of a composite map, arranged in accordance with at least some embodiments described herein. FIG. 3 is substantially similar to system 100 of FIG. 1, with additional details. Those components in FIG. 3 that are labeled identically to components of FIG. 1 will not be described again for the purposes of clarity.

In an example, device 110 may display a composite map 300 that may include indication 140. Composite map 300 may further include instructions effective to navigate device 110 towards the location of vehicle 120. User 102 may identify the instructions in composite map 300 on display 118 of device 110 in order to navigate device 110 towards the location of vehicle 120.

In the example, device 110 may send request 108 to vehicle 130 to request the indication of the location of vehicle 120. Request 108 may include vehicle identification 121. In some examples, device 110 may broadcast request 108 to more than one vehicle within communication range 116. In some examples, device 110 may further include protocols to randomly or selectively identify a vehicle that may receive request 108. A processor of vehicle 130 may identify vehicle identification 121 from request 108 in response to receiving request 108. In response to identification of vehicle identification 121, the processor of vehicle 130 may search for the vehicle identification 121 in location data 138 stored in memory 134. The processor of vehicle 130 may detect an absence of vehicle identification 121 in location data 138. In response to detecting the absence of vehicle identification 121 in location data 138, the processor of vehicle 130 may send request 108 to one or more vehicles, such as vehicles 150, 160, within communication range 136.

A processor of vehicle 160 may receive request 108 and, in response, may search for vehicle identification 121 in location data 168 stored in memory 164. Vehicle 160 may detect a presence of vehicle identification 121 in location data 168 and in response, may send location data 168 and/or vehicle identification 261 to vehicle 130. The processor of vehicle 130 may receive location data 168 and/or vehicle identification 261 and, in response, may retrieve location data 138 and/or vehicle identification 231. Vehicle 130 may send location data 138, 168 and/or vehicle identifications 231, 261 to device 110. Location data may include indications of locations of vehicles and may include map data that includes maps of vehicles. In some examples, the processor of vehicle 130 may add an index to each location data in order to show a correspondence between each location data and a respective vehicle. For example, the processor of vehicle 130 may add a portion of vehicle identification 231 to location data 138 to show that location data 138 corresponds to vehicle 130. The processor of vehicle 130 may add a portion of vehicle identification 261 to location data 168 to show that location data 168 corresponds with vehicle 160.

Device processor 112 of device 110 may receive location data 138, 168 that may include respective map data and/or vehicle identifications 231, 261. Device processor 112 may be configured to analyze received location data in order to identify map data that may be used to generate composite map data for composite map 300. In response to receiving location data 138, 168 and/or vehicle identifications 231, 261, device processor 112 may store location data 138, 168 and/or vehicle identification 231, 261 in device memory 114.

Device processor 112 may combine map data in location data 138 with map data in location data 168 to generate composite map data that corresponds to composite map 300. Device processor 112 may display composite map 300 on display 118. In some examples, composite map 300 may include an instruction, such as a path 302 (depicted), effective to navigate device 110 towards the location of vehicle 120. User 102 may view composite map 300 on display 118 of device 110 in order to identify path 302 to navigate device 110 towards the location of vehicle 120.

In some examples, the processor of vehicle 130 may be configured to perform the above operations relating to generation of composite map data that corresponds to composite map 300. For example, the processor of vehicle 130 may analyze location data 138, 168 in order to generate composite map data that corresponds to composite map 300. Vehicle 130 may send the composite map data that corresponds to composite map 300 to device 110. Device 110 may receive the composite map data that corresponds to composite map 300 and in response, may display composite map 300 on display 118.

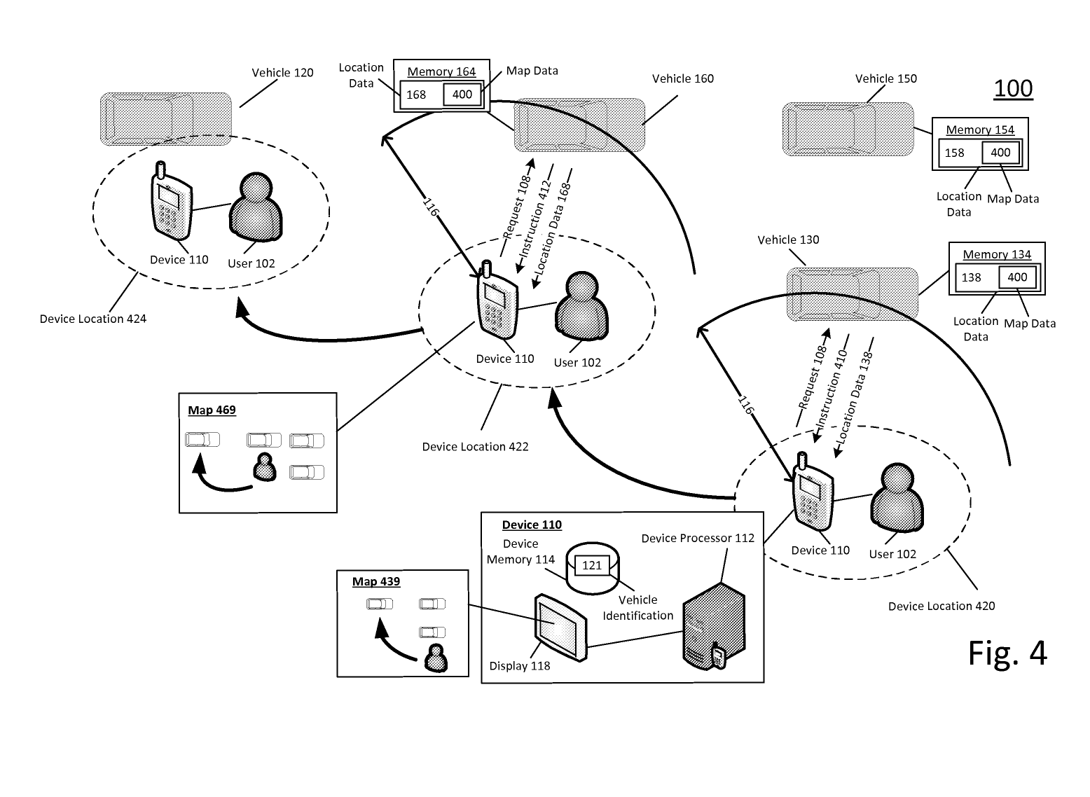

FIG. 4 illustrates system 100 of FIG. 1 relating to an implementation of vehicle location indicator, where location data of vehicles changes as a location of a requesting device changes, arranged in accordance with at least some embodiments described herein. FIG. 4 is substantially similar to system 100 of FIG. 1, with additional details. Those components in FIG. 4 that are labeled identically to components of FIG. 1 will not be described again for the purposes of clarity.

When device 110 is in a particular device location, vehicles within communication range 116 of device 110 may provide respective location data and instructions effective to navigate device 110 towards the location of vehicle 120. For example, device 110 may receive first location data and a first instruction in a first device location, and may receive second location data and a second instruction at a second device location, as will described in more detail below.

Memories of vehicles in system 100 may store map data 400 relating to locations of vehicles in system 100. Map data 400 may be generated based on sharing of location data between vehicles within system 100. For example, in response to vehicle 150 entering system 100, vehicle 160 may update location data 168 and map data 400 and may send the updated location data 168 to vehicles within respective communication range of vehicle 160. Similarly, in response to vehicle 150 entering system 100, vehicle 130 may update map data 400 and send location data 138 (with updated map data 400) to vehicles within respective communication range of vehicle 130. After vehicle 150 enters system 100, vehicle 150 may generate location data 158 and may send the generated location data 158 to vehicles within respective communication range of vehicle 150. Vehicles that are able to communicate with vehicle 150 may also send map data 400 to vehicle 150 in order for vehicle 150 to store map data 400. Vehicles that receive updated and/or generated location data may forward the received location data to other vehicles within a respective communication range to ensure map data 400 in each vehicle within system 100 is up to date. Processors of each vehicle within system 100 may generate instructions, based on map data 400, effective to navigate device 110 towards the location of vehicle 120.

In an example, user 102 may navigate device 110 to a device location 420 such that vehicle 130 is within communication range 116 of device 110. Device 110 may send request 108 to vehicle 130 to locate vehicle 120. Request 108 may include vehicle identification 121. Vehicle 130 may identify vehicle identification 121 and may analyze map data 400 stored in vehicle 130. Vehicle 130 may generate an instruction 410 based on the analysis of map data 400. For example, the processor of vehicle 130 may identify the location of vehicle 120 in map data 400 and in response, may generate instruction 410 that is effective to navigate device 110 to a device location 422 that may be between device location 420 and the location of vehicle 120. Vehicle 130 may send instruction 410 to device 110. In some examples, vehicle 130 may also send location data 138 to device 110. Device processor 112 may process location data 138 based on instruction 410 to produce a map 439 that shows location of vehicles indicated by location data 138. Device processor 110 may display map 439 on display 118 of device 110. User 102 may view map 439 on display 118 of device 110.

User 102 may follow instruction 410 and navigate device 110 to device location 422. At device location 422, vehicle 160 may be within communication range 116 of device 110. Device 110 may send request 108 to vehicle 160 to locate vehicle 120. Vehicle 160 may identify the location of vehicle 120 in map data 400 and in response, may generate an instruction 412 that is effective to navigate device 110 to a device location 424 between device location 422 and the location of vehicle 120. In some examples, device location 424 may be the location of vehicle 120. Vehicle 160 may send instruction 412 to device 110. In some examples, vehicle 160 may also send location data 168 to device 110. Device processor 112 may process location data 168 based on instruction 412 to produce map 469 that shows location of vehicles indicated by location data 168. Device processor 110 may display map 469 on display 118 of device 110. User 102 may follow instruction 412 and navigate device 110 to device location 424.

In some examples, instructions 410, 412 may be voice commands to navigate device 110 towards the location of vehicle 120. For example, instruction 410 may be announced through a speaker of device 110 and may provide directions for user 102 to navigate device 110 to device location 422. Instruction 412 may be announced through the speaker of device 110 and may provide directions for user 102 to navigate device 110 to device location 424.

Among other possible benefits, a system in accordance with the disclosure may benefit vehicle owners and parking facility owners. Vehicle owners may locate vehicles parked in a parking lot by using a personal device such as a cellular phone. The system may allow vehicle owners to locate vehicles in areas that do not have communication established with an infrastructure. The system may also allow vehicle owners to locate vehicles in a parking facility that do not have access to positioning systems such as global or local positioning systems. Owners of parking facilities such as parking lots may benefit from the system by avoiding cost and power consumption relating to setup of an infrastructure within the parking facility.

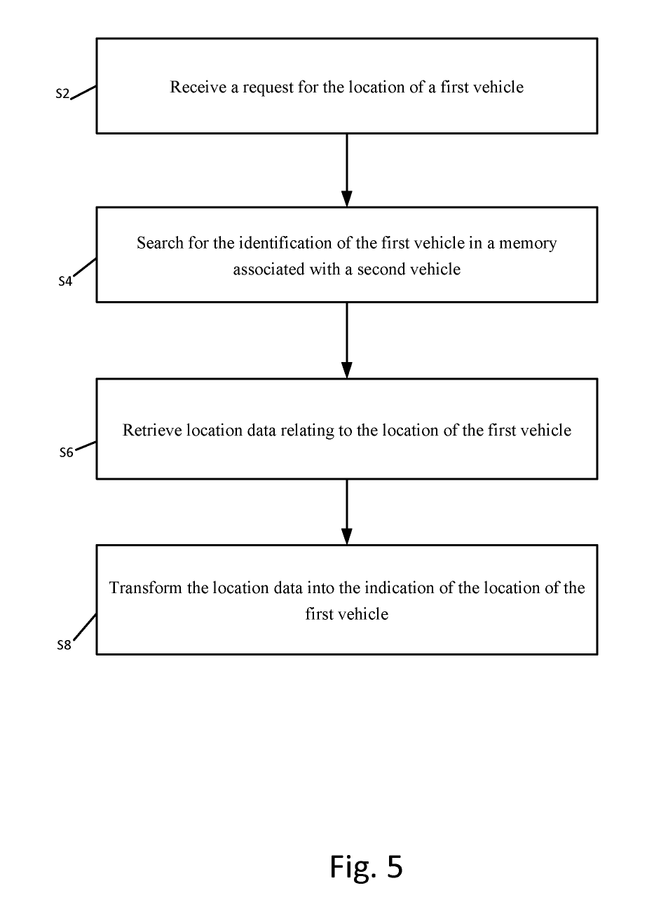

FIG. 5 illustrates a flow diagram for an example process for implementing a vehicle location indicator, arranged in accordance with at least some embodiments presented herein. The process in FIG. 5 could be implemented using, for example, system 100 discussed above. An example process may include one or more operations, actions, or functions as illustrated by one or more of blocks S2, S4, S6, and/or S8. Although illustrated as discrete blocks, various blocks may be divided into additional blocks, combined into fewer blocks, or eliminated, depending on the desired implementation.

Processing may begin at block S2, “Receive a request for the location of a first vehicle”. At block S2, a processor associated with a particular vehicle may receive a request for the location of a first vehicle. The request may include an identification of the first vehicle. In some examples, the particular vehicle may be a second vehicle and the processor may be associated with the second vehicle.

Processing may continue from block S2 to block S4, “Search for the identification of the first vehicle in a memory associated with a second vehicle”. At block S4, the processor may search for the identification of the first vehicle in a memory associated with the second vehicle.

Processing may continue from block S4 to block S6, “Retrieve location data relating to the location of the first vehicle”. At block S6, based on the result of the search, the processor may retrieve location data relating to the location of the first vehicle. In examples where the result of the search indicates a presence of the identification of the first vehicle in the memory, the processor may retrieve the location data from the memory. In examples where the result of the search indicates an absence of the identification of the first vehicle in the memory, the processor may send the request to a processor associated with a third vehicle. The processor may further receive the location data from the processor associated with the third vehicle.

Processing may continue from block S6 to block S8, “Transform the location data into the indication of the location of the first vehicle”. At block S8, the processor may transform the location data into an indication of the location of the first vehicle.

The processor may further send the indication of the location of the first vehicle to a device. The device may be configured to be in communication with the processor. The device may receive the indication of the location of the first vehicle. The device may generate map data based on the indication of the location of the first vehicle. The map data, when displayed on a display of the device, may display a map that may show the location of the first vehicle.

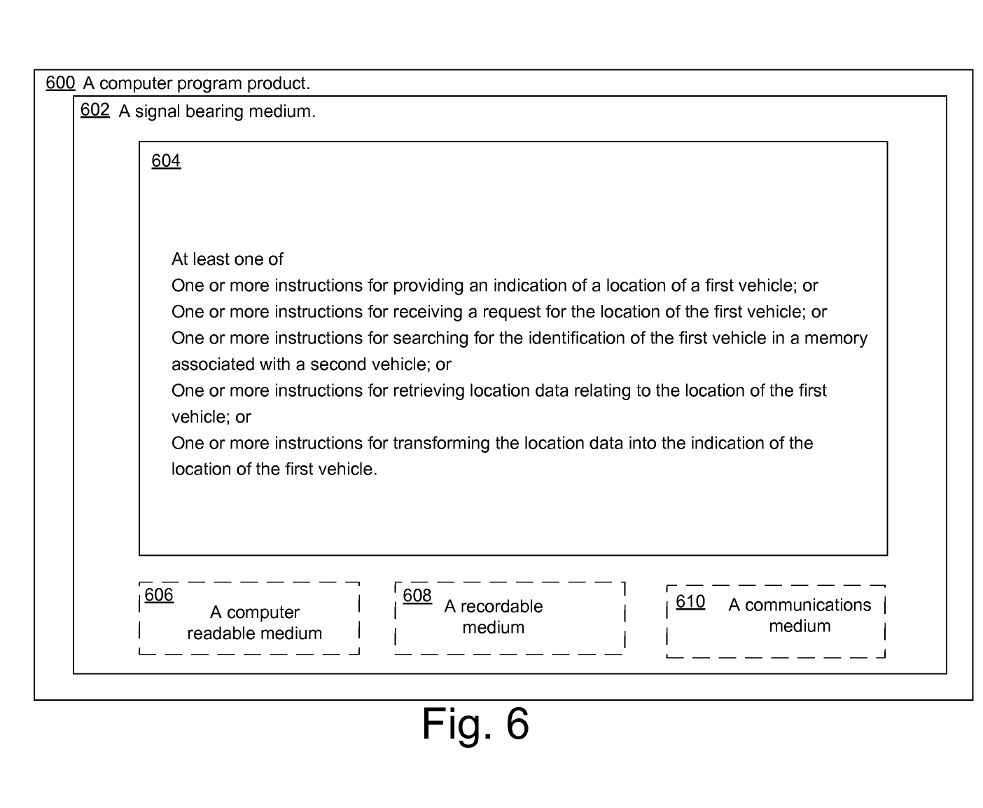

FIG. 6 illustrates an example computer program product 600 that can be utilized to implement a vehicle location indicator, arranged in accordance with at least some embodiments described herein. Program product 600 may include a signal bearing medium 602. Signal bearing medium 602 may include one or more instructions 604 that, when executed by, for example, a processor, may provide the functionality described above with respect to FIGS. 1-5. Thus, for example, referring to system 100, a processor in one or more vehicles, such as vehicle 130, may undertake one or more of the blocks shown in FIG. 6 in response to instructions 604 conveyed to the system 100 by medium 602.

In some implementations, signal bearing medium 602 may encompass a computer-readable medium 606, such as, but not limited to, a hard disk drive, a Compact Disc (CD), a Digital Video Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, program product 600 may be conveyed to one or more modules of the system 100 by an RF signal bearing medium 602, where the signal bearing medium 602 is conveyed by a wireless communications medium 610 (e.g., a wireless communications medium conforming with the IEEE 802.11 standard).

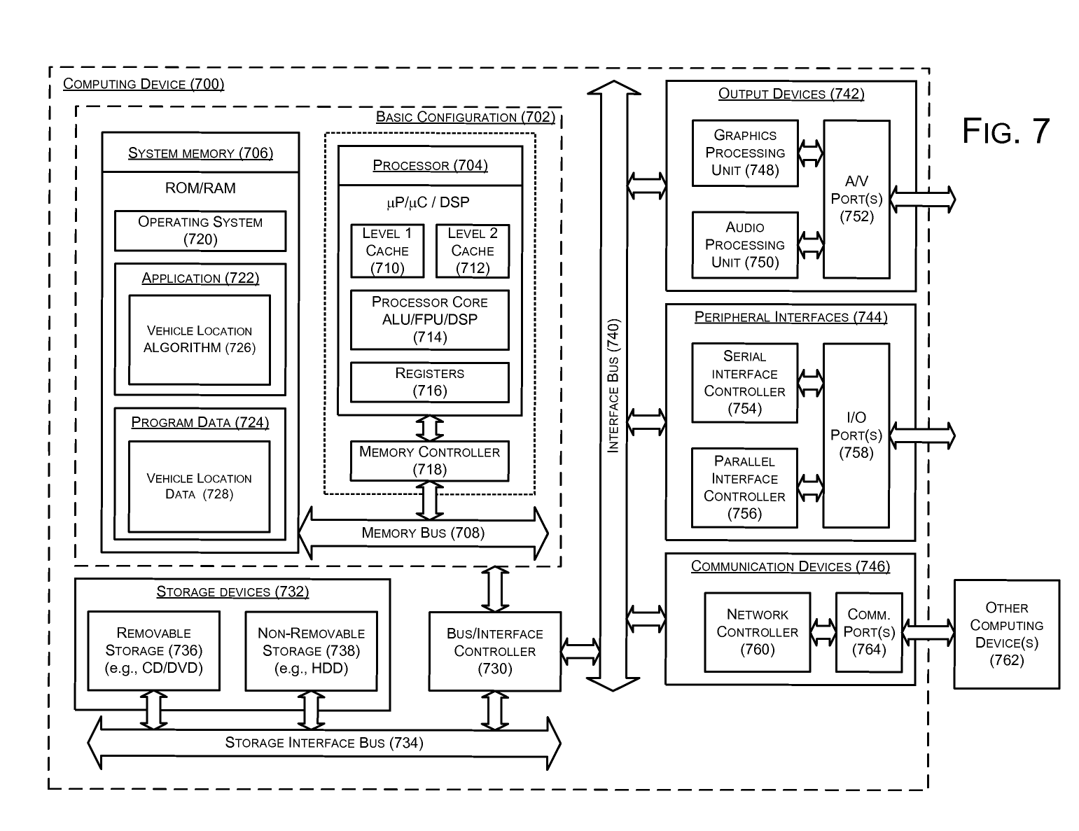

FIG. 7 is a block diagram illustrating an example computing device 700 that is arranged to implement vehicle location indicator, arranged in accordance with at least some embodiments described herein. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include a vehicle location algorithm 726 that is arranged to perform the functions as described herein including those described with respect to system 100 of FIGS. 1-6. Program data 724 may include vehicle location data 728 that may be useful for implementation of a vehicle location indicator as is described herein. In some embodiments, application 722 may be arranged to operate with program data 724 on operating system 720 such that a vehicle location indicator may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will also be understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to provide an indication of a location of a first vehicle, the method comprising, by a processor:
receiving a request for the location of the first vehicle, wherein the request includes an identification of the first vehicle, and the identification is effective to identify the first vehicle;
searching for the identification of the first vehicle in a memory associated with a second vehicle in order to determine a presence of the identification in the memory associated with the second vehicle;
based on a result of the search, retrieving location data relating to the location of the first vehicle; and
transforming the location data into the indication of the location of the first vehicle.

2. The method of claim 1, wherein the processor is associated with the second vehicle.

3. The method of claim 1, further comprising sending the location data to a device configured to be in communication with the processor.

4. The method of claim 3, further comprising, by the device:
receiving the location data; and
generating map data based on the location data, wherein the map data, when displayed on a display of the device, displays a map that includes the indication of the location of the first vehicle.

5. The method of claim 3, wherein the identification of the first vehicle includes information relating to the device.

6. The method of claim 1, further comprising, prior to receiving the request, by a device:
sending an identification request to a processor associated with the first vehicle;
receiving the identification from the processor associated with the first vehicle; and
storing the identification in the device.

7. The method of claim 1, wherein when the result of the search indicates a presence of the identification of the first vehicle in the memory of the second vehicle, the method further comprises retrieving the location data from the memory of the second vehicle.

8. The method of claim 1, wherein when the result of the search indicates an absence of the identification of the first vehicle in the memory of the second vehicle, the method further comprises:
sending the request to a processor associated with a third vehicle; and
receiving the location data from the processor associated with the third vehicle.

9. The method of claim 8, wherein the location data is first location data and the indication is a first indication, and the method further comprises:
retrieving second location data from the memory associated with the second vehicle, wherein the second location data relates to a location of the third vehicle; and
transforming the second location data into a second indication of the location of the third vehicle.

10. The method of claim 9, further comprising generating map data based on the first location data and the second location data, wherein the map data reflects a map that includes the first and second indications.

11. A method to generate composite map data, the method comprising, by a processor:
receiving a request for a location of a particular vehicle, and the request includes an identification of the particular vehicle, wherein the identification is effective to identify the particular vehicle;
identifying first location data that relates to a first location of a first vehicle, wherein the identifying the first location data is based on a presence of the identification of the particular vehicle in a first memory;
identifying second location data that relates to a second location of a second vehicle configured to be in communication with the first vehicle over a network, wherein the identifying the second location data is based on a presence of the identification of the particular vehicle in a second memory;
transforming the first location data into first map data;
transforming the second location data into second map data; and
generating the composite map data based on the first map data and second map data, wherein the composite map data includes an indication of the particular location of the particular vehicle.

12. The method of claim 11, wherein the processor is associated with the first vehicle.

13. The method of claim 11, further comprising:
receiving the request from a device for the composite map data; and
sending the composite map data to the device.

14. The method of claim 13, further comprising:
detecting that the device is effective to communicate with the processor; and
wherein retrieving the first location data is performed in response to the detection.

15. The method of claim 13, wherein the composite map data includes an instruction effective to navigate the device toward the particular location of the particular vehicle.

16. The method of claim 11, wherein the request is a first request, the method further comprising:
receiving the first request, by the processor, from a device, wherein the first request identifies the device at a first device location;
in response to the first request, sending, by the processor, a first instruction to the device, wherein the first instruction is effective to navigate the device from the first device location toward the second location of the second vehicle;
receiving, by a processor associated with a third vehicle, a second request from the device, wherein the second request is for the particular location of the particular vehicle and identifies the device at a second device location; and
sending, by the processor associated with the third vehicle and in response to the second request, a second instruction to the device, wherein the second instruction is effective to navigate the device from the second device location toward the particular location of the particular vehicle.

17. The method of claim 16, wherein:
sending the first instruction to the device further comprises sending a first portion of the composite map data to the device; and
sending the second instruction to the device further comprises sending a second portion of the composite map data to the device.

18. A system effective to provide an indication of a location of a first vehicle, the system comprising:
a memory in a second vehicle;
a component configured to be in communication with the memory, the component configured to:
receive a request from a device for the location of the first vehicle, wherein the request includes an identification of the first vehicle, and the identification is effective to identify the first vehicle;
search for the identification of the first vehicle in the memory of the second vehicle in order to determine a presence of the identification in the memory of the second vehicle;
based on a result of the search, retrieve location data relating to the location of the first vehicle;
send the location data to the device; and
transform the location data into the indication of the location of the first vehicle.

19. The system of claim 18, wherein the component is inside of the second vehicle.

20. The system of claim 18, further comprising the device, wherein the device is configured to:
receive the location data of the first vehicle; and
generate map data based on the location data, wherein the map data, when displayed on a display of the device, displays a map that shows the location of the first vehicle.

21. The system of claim 18, wherein when the result of the search indicates a presence of the identification of the first vehicle in the memory of the second vehicle, the component is further configured to retrieve the location data from the memory of the second vehicle.

22. The system of claim 18, wherein when the result of the search indicates an absence of the identification of the first vehicle in the memory of the second vehicle, the component is further configured to:
send the request to a processor associated with a third vehicle; and
receive the location data from the processor associated with the third vehicle.

23. The system of claim 22, wherein the location data is first location data and the indication is a first indication, and the component is further configured to:
retrieve second location data from the memory of the second vehicle, wherein the second location data relates to a location of the third vehicle;
transform the second location data into a second indication of the location of the third vehicle; and
generate map data based on the first location data and the second location data, wherein the map data reflects a map of the first and the third vehicles.

24. A method to determine an indication of a location of a vehicle, the method comprising, by a device:
generating a request using an identification of the vehicle, wherein the request is for the location of the vehicle, the request includes an identification of the vehicle, and the identification is effective to identify the vehicle;
sending the request to a processor;
receiving location data from the processor in response to sending the request, wherein the location data relates to the location of the vehicle; and
transforming the location data into the indication of the location of the vehicle.

25. The method of claim 24, wherein the vehicle is a first vehicle, and the processor is associated with a second vehicle.

26. The method of claim 24, further comprising:
generating map data based on the location data, wherein the map data, when displayed on a display of the device, displays a map that shows the location of the vehicle; and
displaying the map on the display of the device.

27. The method of claim 24, further comprising, prior to generating the request:
sending an identification request to a processor associated with the vehicle;
receiving the identification from the processor associated with the vehicle in response to sending the identification request; and
storing the identification in a memory of the vehicle.

28. The method of claim 24, wherein the identification of the vehicle includes information relating to the device.

29. A device configured to determine an indication of a location of a vehicle, the device comprising:
a memory configured to store an identification of the vehicle, wherein the identification of the vehicle is associated with the device;
a component configured to be in communication with the memory, the component being configured to:
generate a request with use of the identification of the vehicle, wherein the request is for the location of the vehicle;
send the request to a processor;
receive location data from the processor in response to the request, wherein the location data relates to the location of the vehicle; and
transform the location data into the indication of the location of the vehicle.

30. The device of claim 29, wherein the component is further configured to:
generate map data based on the location data, wherein the map data, when displayed on a display of the device, displays a map that shows the location of the first vehicle; and
display the map on the display of the device.
